(19) United States
(12) Patent Application Publication
(10) Pub. No.: US 2010/0103110 A1
(43) Pub. Date: Apr. 29, 2010

(54) INPUT APPARATUS WITH PROGRAMMABLE DISPLAY

(75) Inventor: Jung Chi Lai, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DARFON ELECTRONICS CORP., Taoyuan (TW)

(21) Appl. No.: 12/607,792

(22) Filed: Oct. 28, 2009

(30) Foreign Application Priority Data
Oct. 29, 2008 (TW) 097219338

(51) Int. Cl. G06F 3/02; H01H 9/00

(52) U.S. Cl. 345/168; 200/314

(57) ABSTRACT

The invention discloses an input apparatus with a programmable display. The input apparatus includes a body, at least one keyswitch, a plural of light-emitting units, and a control unit. The at least one keyswitch is disposed on the body and has a respective translucent keycap. The light-emitting units are disposed inside the body and for illuminating the respective keycap. The control unit is disposed inside the body and coupled to the at least one keyswitch and the light-emitting units. According to an application program, the control unit is for controlling the light-emitting units to display a displayed information on the respective keycap of the at least one keyswitch.

### BACKGROUND OF THE INVENTION

1. Field of the Invention

The invention relates to an input apparatus, and particularly, the invention relates to an input apparatus with a programmable display.

2. Description of the Prior Art

With the vigorous development of the integrated circuits and the semiconductor, the computer system is popularized to the personal user but not limited to the applications of national defense or industry. Generally, the computer system communicates with the user through the peripheral, such as the input apparatus or the out apparatus, connected to the computer system. The output apparatus includes the display and the speaker. The input apparatus includes the mouse and the keyboard for inputting the word information or controlling the frame on the display.

At present, the input apparatus such as the keyboard or the mouse of the computer system only has the function of one way input, and it is dull and toneless for the person user. However, following the advancement of technology, it is emphasized that the electronic product should be interacting and entertaining. If the input apparatus could not provide the additional functions such as the human machine interaction or the acousto-optic feedback besides the fundamental input function, the product might lose the competency on the market.

Therefore, the major scope of the invention is to provide an input apparatus with a programmable display for solving the above problem.

### SUMMARY OF THE INVENTION

A scope of the invention is to provide an input apparatus with a programmable display.

According to an embodiment of the invention, the input apparatus includes a body, at least one keyswitch, a plurality of light-emitting units, and a control unit. The at least one keyswitch is disposed on the body and has a respective translucent keycap. The plurality of light-emitting units are disposed inside the body and for illuminating the respective keycap of the at least one keyswitch. The control unit is disposed inside the body and coupled to the at least one keyswitch and the light-emitting units, wherein the control unit could control the light-emitting units to display a displayed information on the respective keycap of the at least one keyswitch according to an application program.

According to another embodiment, the input apparatus includes a body, at least one touch keyswitch, a plurality of light-emitting units, and a control unit. The at least one touch keyswitch is disposed on the body and has a respective display panel. The plurality of light-emitting units are disposed inside the body and for illuminating the respective display panel of the at least one touch keyswitch. The control unit is disposed inside the body and coupled to the at least one touch keyswitch and the light-emitting units, wherein the control unit could control the light-emitting units to display a displayed information on the display panel of the at least one touch keyswitch according to an application program.

The advantage and spirit of the invention may be understood by the following recitations together with the appended drawings.

### BRIEF DESCRIPTION OF THE APPENDED DRAWINGS

FIG. 1 is a function block diagram illustrating the input apparatus according to an embodiment of the invention.

FIG. 2A is a framework diagram illustrating the input apparatus according to an embodiment of the invention.

FIG. 2B is a framework diagram illustrating the input apparatus according to another embodiment of the invention.

FIG. 3 is a schematic diagram illustrating the input apparatus is coupled to an external electronic device according to an embodiment of the invention.

FIG. 4A and FIG. 4B is the schematic diagrams illustrating that the keyswitch of the input apparatus displays the expanding menu with layers according to an embodiment of the invention.

### DETAILED DESCRIPTION OF THE INVENTION

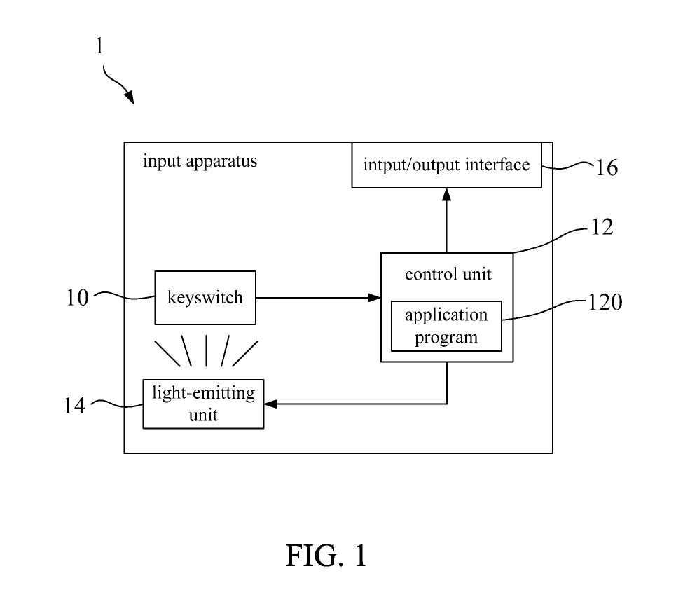

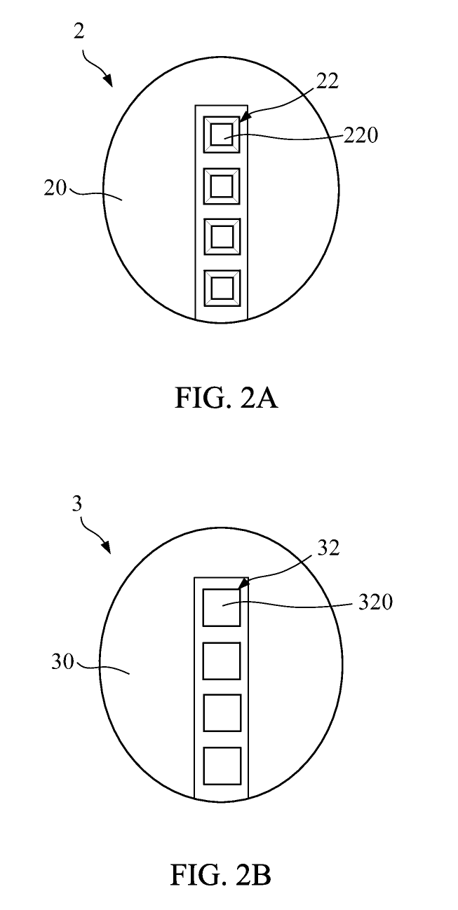

Please refer to FIG. 1, FIG. 2A, and FIG. 2B. FIG. 1 is a function block diagram illustrating the input apparatus 1 according to an embodiment of the invention. FIG. 2A is a framework diagram illustrating the input apparatus 2 according to another embodiment of the invention. FIG. 2B is a framework diagram illustrating the input apparatus 3 according to an embodiment of the invention. The input apparatuses (2, 3) include the bodies (20, 30) and at least one keyswitches (22, 32) disposed thereon.

In practice, the shape of the body could be designed according to the requirement of the market or the fashion trend. For example, it could be designed as the famous cartoon character or robot to attract the user.

As shown in FIG. 2A, each of the keyswitch 22 has a keycap 220 respectively in an embodiment. For example, the type of the keyswitch 22 could be similar to the keyswitch of the general keyboard. Particularly, the keycap 220 of the keyswitch 22 could be entirely translucent or partly translucent (such as, only the upper surface is translucent). In another embodiment, each of the keyswitch 32 could be a touch keyswitch and has a display panel 320 respectively, as shown in FIG. 2B.

The plurality of light-emitting units 14 are disposed in the body for illuminating the keycap 220 of the keyswitch 22 shown in FIG. 2A or the display panel 320 of the touch keyswitch 32 as shown in FIG. 2B. In practice, the plurality of light-emitting units 14 could be light-emitting diodes. The control unit 12 is disposed inside the body and coupled to the at least one keyswitch 10 and the light-emitting units 14, wherein the control unit 12 could control the light-emitting units 14 to display a displayed information on the keycap or the display panel according to a application program 120. In practice, the display information could include word information and/or pattern information. Besides, the displayed information could be static or dynamic (such as the marquee).

Besides, the keyswitch 10 of the input apparatus 1 could generates an input signal corresponding to the pressing of a user to the control unit 12, and then the control unit 12 could control the light-emitting units 14 to display another displayed information on the keyswitch 10 according to the input signal and the application program 120. Furthermore, the control unit 12 could control the light-emitting units 14 to illuminate the at least one keyswitch 10 to display an expanding menu with layers for the user.

As shown in FIG. 1, the input apparatus 1 of the invention could further include an input/output interface 16. The input/output interface 16 could be coupled to an external electronic device by wire or wireless way. The input/output interface 16 is coupled to the control unit and for outputting a selecting signal generated by the control unit 12 to the external electronic device, wherein the selecting signal is generated correspondingly to a user pressing the keyswitch 10.

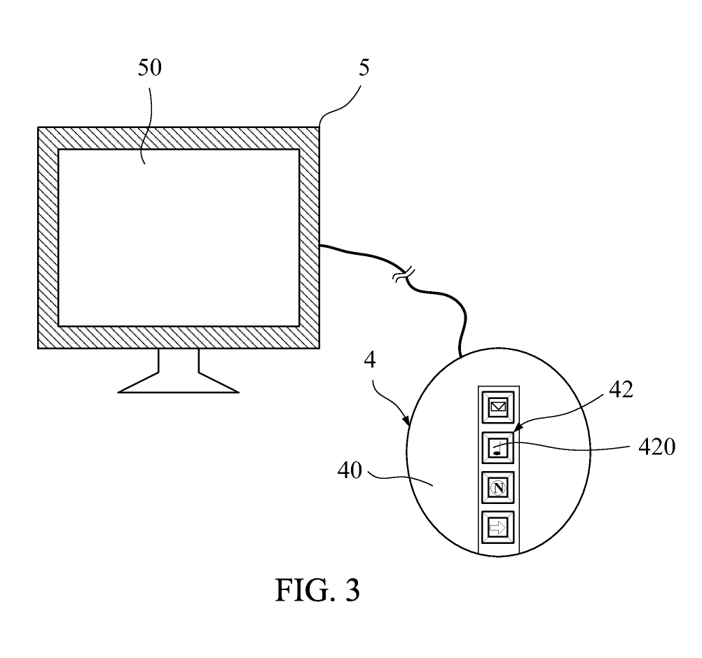

Please refer to FIG. 3. FIG. 3 is a schematic diagram illustrating the input apparatus 4 is coupled to an external electronic device 5 according to an embodiment of the invention. In practice, the external electronic device could be a computer (as shown in FIG. 3) or a media player (for MP3 or MP4). The selecting signal could be transferred to the external electronic device for controlling the external electronic device to executing specific functions, such as playing music or video, connecting to internet, or checking email.

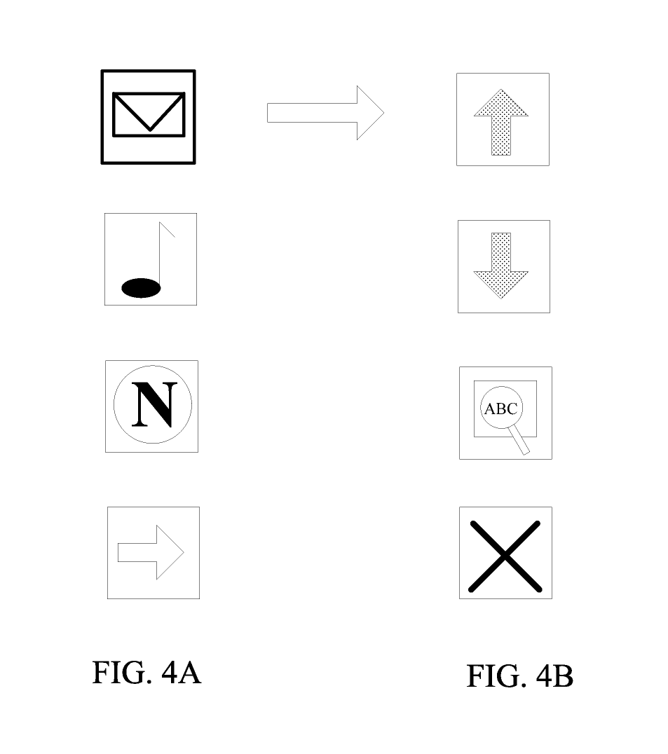

For the details of the invention, an embodiment is recited in the following. FIG. 4A and FIG. 4B is the schematic diagrams illustrating that the keyswitch of the input apparatus displays the expanding menu with layers according to an embodiment of the invention. As shown in FIG. 4A, the input apparatus could includes four keyswitches (keycap type or touch type) in this embodiment, however, it is not a limitation in practice. Besides, the input apparatus in this embodiment could be coupled to the computer as shown in FIG. 3.

Generally, the control unit could control the light-emitting units to display the pattern information representing “checking email”, “playing music”, “connecting to internet”, and “others” on the four keyswitches in a top-down sequence, and it is the menu of the first layer.

When the user press the keyswitch displaying “checking email”, the control unit could generate a selecting signal correspondingly and then transfer the selecting signal to the computer through the input/output interface to cause the computer to execute the email program and display it on the display panel 50 shown in FIG. 3. At the same time, the keyswitch could generate the corresponding input signal to the control unit, and then the control unit controls the light-emitting units to redisplay the pattern information representing “the last email”, “the next email”, “browse”, and “close the email” on the four keyswitches in a top-down sequence, and it is the menu of the second layer. At this time, the user could select and press the keyswitch according to the requirement again to control the computer to execute the further function or close the email. It should be noted that although there are only two layers disclosed in this embodiment, the number and the contents of the layers of the menu are not limited to the embodiment.

Compared to the prior art, the input apparatus with a programmable display could dynamically change the display information on the keyswitch according to the invention. Besides making the keyswitch to display the information of various events, the corresponding functions could be executed via the keyswitch. Furthermore, the input apparatus could provide the menu with layers through the combination of the plurality of keyswitches.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An input apparatus with a programmable display, comprising:
a body;
at least one keyswitch, disposed on the body and having a respective translucent keycap;
a plurality of light-emitting units, disposed inside the body, the light-emitting units being for illuminating the respective keycap of the at least one keyswitch; and
a control unit, disposed inside the body and coupled to the at least one keyswitch and the light-emitting units, the control unit controlling the light-emitting units to display a first displayed information on the respective keycap of the at least one keyswitch according to an application program.

2. The input apparatus of claim 1, wherein the at least one keyswitch is capable of generating an input signal correspondingly to the pressing of a user to the control unit, the control unit controls the light-emitting units to display a second displayed information on the respective keycap of the at least one keyswitch according to the input signal and the application program.

3. The input apparatus of claim 2, wherein the control unit further controls the light-emitting units to illuminate the respective keycap of the at least one keyswitch to display an expanding menu with layers for the user.

4. The input apparatus of claim 1, wherein the first displayed information comprises word information and pattern information.

5. The input apparatus of claim 1, wherein the first displayed information is static or dynamic.

6. The input apparatus of claim 1, wherein the light-emitting units are light-emitting diodes.

7. The input apparatus of claim 1, further comprising
an input/output interface, coupled to the control unit, the input/output interface being for outputting a selecting signal generated by the control unit to an external electronic device, the selecting signal being generated correspondingly to a user pressing the at least one keyswitch.

8. An input apparatus with a programmable display, comprising:
a body;
at least one touch keyswitch, disposed on the body and having a respective display panel;
a plurality of light-emitting units, disposed inside the body, the light-emitting units being for illuminating the respective display panel of the at least one touch keyswitch; and
a control unit, disposed inside the body and coupled to the at least one touch keyswitch and the light-emitting units, the control unit controlling the light-emitting units to display a first displayed information on the respective display panel of the at least one touch keyswitch according to an application program.

9. The input apparatus of claim 8, wherein the at least one touch keyswitch is capable of generating an input signal correspondingly to the pressing of a user to the control unit, the control unit controls the light-emitting units to display a second displayed information on the respective display panel of the at least one touch keyswitch according to the input signal and the application program.

10. The input apparatus of claim 9, wherein the control unit further controls the light-emitting units to illuminate the respective display panel of the at least one touch keyswitch to display an expanding menu with layers for the user.

11. The input apparatus of claim 8, wherein the first displayed information comprises word information and pattern information.

12. The input apparatus of claim 8, wherein the first displayed information is static or dynamic.

13. The input apparatus of claim 8, wherein the light-emitting units are light-emitting diodes.

14. The input apparatus of claim 8, further comprising
an input/output interface, coupled to the control unit, the input/output interface being for outputting a selecting signal generated by the control unit to an external electronic device, the selecting signal being generated correspondingly to a user pressing the at least one touch keyswitch.
